(19) United States
(12) Patent Application Publication
(10) Pub. No.: US 2025/0134090 A1
(43) Pub. Date: May 1, 2025

(54) CLOSING DEVICE AND EXTRACTING DEVICE OF PHYTOSANITARY PRODUCT

(71) Applicant: EXEL INDUSTRIES, EPERNAY (FR)

(72) Inventors: Thibault BACLE, LYON (FR); Mathieu PARLANT, EPERNAY (FR)

(73) Assignee: EXEL INDUSTRIES, EPERNAY (FR)

(21) Appl. No.: 18/888,911

(22) Filed: Sep. 18, 2024

(30) Foreign Application Priority Data
Oct. 26, 2023 (FR) 2311673

(51) Int. Cl. A01M 7/00; B05B 9/047

(52) U.S. Cl. CPC A01M 7/0089; A01M 7/0032; B05B 9/047

(57) ABSTRACT

The present invention relates to a closing device configured to close a can of phytosanitary product, the closing device having a bottom wall having at least three through openings, and a peripheral wall protruding from the bottom wall, a first opening being configured to be connected to an outlet of phytosanitary product allowing the phytosanitary product to be discharged from the can, a second opening being configured to open in a sealed manner into an inflatable membrane and to be connected to an inlet of a pneumatic circuit, so as to allow an overpressure to be generated in the can by the expansion of the inflatable membrane by the pneumatic circuit, a third opening being configured to be connected to an inlet of a hydraulic flushing circuit.

### TECHNICAL FIELD

The present invention relates to the field of agricultural spraying.

In particular, the present invention relates to a closing device intended to cooperate with a can of phytosanitary product for agricultural sprayer.

The invention also relates to an extracting device of phytosanitary product provided with such a closing device.

The invention also relates to an agricultural machine comprising such an extracting device.

### BACKGROUND

Methods for spraying liquid under pressure, in particular agricultural phytosanitary products and apparatuses intended for such sprayings are known. In particular, in such apparatuses, a constant pressure of water or air is applied to an expandable membrane that inflates and tends to conform to the inner contour of a container in which the liquid to be sprayed is contained in such a way as to cause the ejection of the latter. The liquid to be sprayed is conveyed, by the swelling of the membrane, to a discharge duct for liquid to be sprayed. More specifically, according to the state of the art, for a correct discharge of the liquid to be sprayed, air injection to inflate the membrane is carried out on one side of the container and the discharge of the liquid to be sprayed is carried out from the opposite side of the container. In fact, when the membrane inflates on one side of the container, it will allow the liquid to be pushed from the opposite side of the container towards the discharge duct and thus allow its discharge through the said duct.

However, such apparatuses with this type of spraying require a container containing the particular liquid to be sprayed, an installation of a water or air inlet and an outlet for liquid to be sprayed on two opposite sides. Thus, the container is specific to the apparatus and the latter is bulky.

The present invention therefore aims to solve the aforementioned problems by providing a closing device configured to cooperate with a can of phytosanitary product and configured to facilitate and allow the discharge of a phytosanitary product. As the said device can be adapted to different standard cans, it is convenient and economical, but also allows a certain ergonomics of the agricultural spraying system for which the closing device is intended.

### SUMMARY OF THE INVENTION

More specifically, the invention relates to a closing device configured to cooperate with a hydraulic flushing circuit, with a pneumatic circuit for agricultural spraying system, with an outlet of phytosanitary product and with a can of phytosanitary product, the closing device comprising at least a bottom wall and at least a peripheral wall. The closing device is configured to close the can. The peripheral wall protruding from the bottom wall, the bottom wall comprising at least three through openings, namely a first opening, a second opening and a third opening, the first opening being configured to be connected to the outlet of phytosanitary product allowing the said phytosanitary product to be discharged from said can, the second opening being on the one hand configured to open in a sealed manner into an inflatable membrane and on the other hand configured to be connected to an inlet of the pneumatic circuit, so as to allow an overpressure to be generated in the can by the expansion of the inflatable membrane by means of the pneumatic circuit, said third opening being configured to be connected to an inlet of said hydraulic flushing circuit.

The closing device according to the invention can be single-use or reusable. It allows, through its first opening, to discharge the phytosanitary product contained in the can on which it is fixed. Through its second opening, the closing device allows the inflatable membrane to be inflated and deflated in order to facilitate the discharge of the phytosanitary product from the can. Through its third opening, the closing device also allows the flushing of the can and the inflatable membrane. The closing device is adaptable to any type of standard or non-standard can and has the advantage of being compact, economical and ergonomic.

Advantageously, the closing device according to the invention further comprises an inflatable membrane, said inflatable membrane being connected to the second opening of the bottom wall, said inflatable membrane being configured to expand and/or contract by means of the pneumatic circuit, the inflatable membrane being disposed on the same side of the bottom wall as the peripheral wall.

The inflatable membrane allows, through its expansion, to generate an overpressure in the can. In particular, the inflatable membrane is connected to the second opening of the bottom wall and is configured to expand and/or contract by means of the pneumatic circuit. It is configured to expand and retract in the can, once the closing device is installed on the can. The expansion of the inflatable membrane and the overpressure generated in the can allow the delivery of the phytosanitary product to be sprayed contained in the can to the first opening of the closing device connected to an outlet of phytosanitary product during the use of the closing device.

More advantageously, the inflatable membrane can be a flexible expandable membrane.

The flexible extendable membrane is configured to, when it expands under the action of the pneumatic circuit, conform to the internal wall of the can and allow all the phytosanitary product contained in the can, to be pushed out of the can. In particular, it facilitates the discharge of the entire phytosanitary product from the can, even the liquid stuck in an irregularity of the can wall.

The invention also related to an extracting device of phytosanitary product from a can comprising at least a closing device as briefly described above, at least a pneumatic circuit and at least an outlet of phytosanitary product, said closing device comprising at least an inflatable membrane, at least a bottom wall and at least a peripheral wall protruding from the bottom wall, said bottom wall comprising at least two through openings, a first opening and a second opening, the first opening being connected to an outlet of phytosanitary product allowing the said phytosanitary product to be discharge from said can, the second opening being on the one hand connected to the inflatable membrane and on the other hand connected to an inlet of pneumatic circuit, said inflatable membrane being configured to expand and/or contract by means of the pneumatic circuit, the inflatable membrane being disposed on the same side of the bottom wall as the peripheral wall.

The closing device is configured to close a can. The pneumatic circuit, connected to the closing device through its second opening allows the expansion of the inflatable membrane which itself allows the delivery of the phytosanitary product towards the outlet of phytosanitary product so that it can be sprayed by a spraying boom.

According to one embodiment, the pneumatic circuit comprises at least a duct, a distributor, a pressure regulator and a compressed air inlet, the duct connecting the closing device to the distributor, which is itself connected by said duct to the pressure regulator connected to the compressed air inlet, said pneumatic circuit being configured to allow the expansion of the inflatable membrane.

The compressed air inlet conveys compressed air to the pressure regulator which allows the air pressure to be maintained and controlled. In particular, the regulator allows the compressed air to be delivered at the desired pressure to the closing distributor. The injection of air into the inflatable membrane allows the expansion of said membrane, which generates an overpressure in the can. The expansion of the inflatable membrane and the overpressure generated in the can allow the liquid to be sprayed to be conveyed to the first opening of the closing device connected to an outlet of phytosanitary product.

More advantageously, the pneumatic circuit further comprises a vacuum generator, said duct connecting the vacuum generator to the distributor, said vacuum generator being configured to suck in the air contained in the inflatable membrane, causing its contraction.

Once the can is emptied of the phytosanitary product, the vacuum generator allows to suck in the air contained in the inflatable membrane, which causes its contraction in the can.

More advantageously, the pneumatic circuit further comprises a duct, an air flushing distributor and a pressure regulator, said duct connecting the compressed air inlet to the pressure regulator, which is itself connected by said duct to the air flushing distributor, which is itself connected to the outlet of phytosanitary product, said pneumatic circuit being configured to allow the air flushing of the outlet of phytosanitary product.

The compressed air inlet conveys compressed air to the pressure regulator that maintains and controls the air pressure, then to the air flushing distributor before conveying it through the duct of the outlet of phytosanitary product, up to the spray boom. The injection of air into the ducts up to the spray boom allows to flush with air the ducts through which the sprayed phytosanitary product was conveyed. In particular, the pneumatic circuit allows here the phytosanitary product particles remaining in the ducts to be discharged.

Advantageously, the extracting device according to the invention also comprises a hydraulic flushing circuit and in which the bottom wall of said closing device has a third through opening connecting to an inlet of said hydraulic flushing circuit, configured to allow the flushing of the can and the inflatable membrane.

The hydraulic flushing circuit allows the delivery of a flushing liquid such as clear water to the third opening of the closing device, and then into the can. Said hydraulic circuit is configured to flush the can with the flushing liquid, once the phytosanitary product has been discharged. In particular, the hydraulic flushing circuit allows the phytosanitary product particles remaining in the can to be discharged. Thus, the hydraulic circuit prevents the stagnation of the phytosanitary product in the can but also on the inflatable membrane.

The invention also relaters to a liquid spraying system comprising an extracting device as briefly described above and further comprising a can configured to contain a phytosanitary product and to which said closing device is fixed, the can being on the other hand connected, by the first opening of the closing device, to a duct of the outlet of treatment liquid configured to convey the phytosanitary product from the can to at least one spraying nozzle, the can being on the other hand connected by the third opening of the closing device to an inlet duct of the hydraulic flushing circuit configured to convey flushing liquid into the can so that said flushing liquid flushes said can, and said can being connected by the second opening of the closing device to an inlet duct of the pneumatic circuit and to the inflatable membrane, said inlet duct of the pneumatic circuit being configured to convey fluid into the inflatable membrane so that it expands into the can enclosure, the expansion of said inflatable membrane being configured to pressurize the phytosanitary product in the can so as to create a flow of said phytosanitary product towards the outlet of phytosanitary product.

According to one embodiment, the spraying system comprises a pressurized enclosure, the can and the extracting device being disposed inside the pressurized enclosure.

The invention also relates to an agricultural machine comprising a liquid spraying system as briefly described above.

### BRIEF DESCRIPTION OF THE DRAWINGS

The invention will be better understood by reading the description that will follow, given only as an example, and referring to the annexed drawings given as non-exhaustive examples, in which identical references are given to similar objects and on which:

FIG. 1 is a schematic representation of an extracting device of phytosanitary product according to the invention, installed on a can, said extracting device comprising a closing device connected to a pneumatic circuit, an outlet of phytosanitary product and a hydraulic flushing circuit, said closing device comprising an inflatable membrane partially inflated in the can

FIG. 2 is a similar view to FIG. 1, but the inflatable membrane of the closing device is more inflated and conforms to the inner wall of the can;

FIG. 3 is a diagram of the pneumatic circuit shown in FIG. 1, allowing the inflatable membrane of the closing device to be expanded and/or contracted;

FIG. 4 shows a similar embodiment to that in FIG. 3, except that the can and the extracting device are disposed in a pressurized enclosure;

FIG. 5 is identical to FIG. 1, except that the can and the extracting device are disposed in a pressurized enclosure.

It should be noted that the figures describe the invention in detail to enable the invention to be implemented; although not exhaustive, said figures serve in particular to better define the invention if required.

### DETAILED DESCRIPTION OF THE INVENTION

The invention relates to a spraying system comprising a can 2 and an extracting device 1 of phytosanitary product. In particular, the can 2 is intended to contain the phytosanitary product and the extracting device 1 is configured to allow and facilitate the extraction of the phytosanitary product outside the can 2 so that it can be sprayed by the spraying system mounted on an agricultural machine such as an agricultural sprayer.

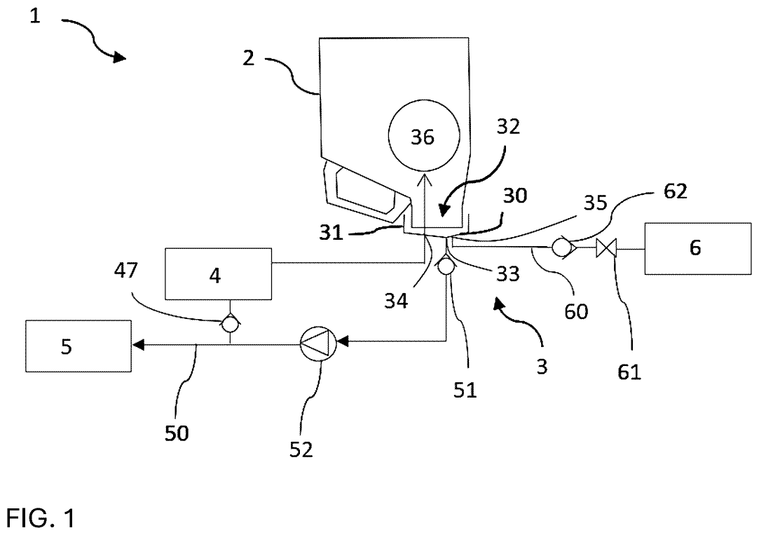

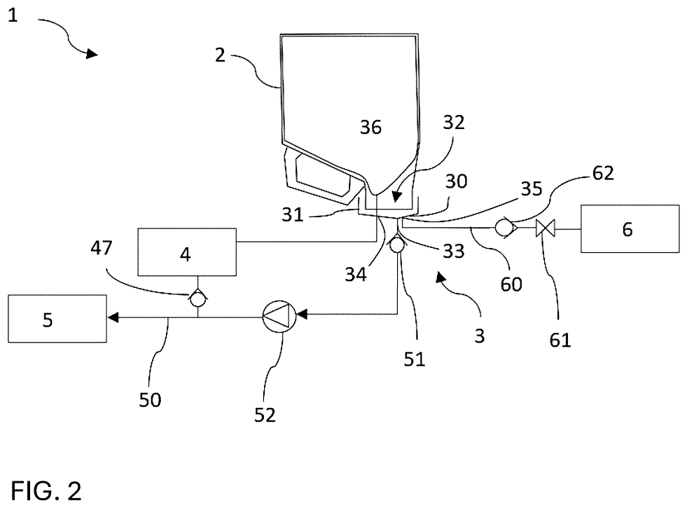

As shown in FIGS. 1 and 2, the extracting device 1 of phytosanitary product comprises at least a closing device 3, at least a pneumatic circuit 4 and at least an outlet of phytosanitary product 5.

The extracting device 1 may further comprise the can 2 and a hydraulic flushing circuit 6 configured to allow the flushing of the can 2.

“Can” means any container of active product, in other words the phytosanitary product, including potentially any type of tank originally containing the phytosanitary product. The term “can” also includes a can into which phytosanitary product is transferred, in particular from a tank.

The can 2 is configured to contain the phytosanitary product. The can 2 is a standardised can or an unknown can in the prior art, having various shapes and volumes. In particular, it may contain phytosanitary liquid for the treatment of plants on which it is sprayed.

The closing device 3 is configured to close the can 2.

In particular, the closing device 3 has at least a bottom wall 30 and at least a peripheral wall 31.

For example, the closing device 3 can take the form of a cap.

The peripheral wall 31 protrudes from the bottom wall 30. In particular, the peripheral wall 31 can extend on the circumference of the bottom wall 30. Said peripheral wall 31 and said bottom wall 30 delimiting a fixing housing 32.

In particular, the peripheral wall 31 is configured to cooperate with the can 2, in order to close the latter.

According to a particular embodiment of the invention, the peripheral wall 31 has a thread configured to adapt to a screw thread of the can 2, and thus allow the closure of the can 2.

According to another embodiment, the peripheral wall 31 may include a clip system configured to cooperate with a complementary clip system present on the can 2, allowing the closure of the can 2.

It goes without saying that the invention is not limited to these two modes of closing the can 2, but applies to any type of closing mode allowing the closure of the can 2 by the closing device 3.

The bottom wall 30 has at least three through openings, namely a first opening 33, a second opening 34 and a third opening 35.

The first opening 33 is configured to be connected to the outlet of phytosanitary product 5, allowing the phytosanitary product contained in the can 2, to be discharged out of said can 2.

The second opening 34 is configured on the one hand to open in a sealed manner into an inflatable membrane 36 and on the other hand to be connected to an inlet of the pneumatic circuit 4, so as to allow an overpressure to be generated in the can 2 by the expansion of the inflatable membrane 36 by means of the pneumatic circuit 4, and to allow the inflatable membrane 36 to be deflated if required.

Advantageously, the extracting device 1 can further comprise a closing member (not shown) between the closing device 3 and the pneumatic circuit 4. The said closing member is then configured to prevent the flow of the phytosanitary product contained in the can 2, in particular by gravity when placing the can 2 in the extracting device 1 or when installing the closing device 3 on the can 2, for example. The closing member can for example be a tap, a standard coupler, etc.

The third opening 35 is configured to be connected to an inlet of the hydraulic flushing circuit 6.

The closing device 3 may further include the inflatable membrane 36.

The inflatable membrane 36 is connected to the second opening 34 of the bottom wall 30. The inflatable membrane 36 is configured to expand and/or contract by means of the pneumatic circuit 4.

The inflatable membrane 36 is disposed on the same side of the bottom wall 30 as the peripheral wall 31. In other words, the inflatable membrane 36 is connected to the second opening 34, in the fixing housing 32.

According to a particular embodiment of the invention, the inflatable membrane 36 is a flexible expandable membrane.

In particular, the flexible expandable membrane is configured to, when it expands under the action of the pneumatic circuit, conform to the inner wall of the can 2, as shown in FIG. 2.

It should be noted that the inflatable membrane 36 can conform to all the walls of the can 2. In other words, the walls of the can 2 delimiting its opening closed by the closing device 3 can also be covered by the flexible membrane 36.

According to another embodiment of the invention, the inflatable membrane 36 may have a predetermined shape corresponding to the shape of the can 2, in particular the shape of the internal volume of the can 2. Under the action of the pneumatic circuit 4, the inflatable membrane 36 expands until it reaches its predetermined shape.

In the extracting device 1 shown in FIGS. 1 and 2, the closing device 3 closes the can 2. In particular, the closing device 3 replaces the cap of the can 2. For this, the closing device 3 is fixed to the can 2, so as to close its opening delimited by its wall.

In particular, the fixing housing 32 is configured to receive a wall portion of the can 2, allowing to close the opening of the can 2. The bottom wall 30 of the closing device 3 is dimensioned to match the opening of the can 2 and the peripheral wall is configured to cooperate with the wall portion of the can 2. For example, the peripheral wall 31 can be, on its inner surface intended to be in contact with the can 2, tapped. The outer wall portion of the can 2, intended to be in contact with the peripheral wall 31 of the closing device 3, may be threaded. The tapping of the peripheral wall 31 corresponds to the threading of the wall portion of the can 2, so that the closing device 3 is fixed to the can 2.

The pneumatic circuit 4 is configured to allow the expansion of the inflatable membrane 36.

In particular, in an initial position corresponding to the position in which the can 2 is completely filled with phytosanitary product, the inflatable membrane 36 is completely retracted and disposed within the can 2. When it is desired to spray phytosanitary product by the agricultural machine, the liquid must be discharged from the can 2. For this, the pneumatic circuit 4 conveys air into the inflatable membrane 36, so as to allow it to expand and generate an overpressure in the can 2. The expansion of the inflatable membrane 36 and the overpressure generated in the can 2 allow the liquid to be sprayed to be conveyed to the first opening 33 of the closing device 3 connected to the outlet of phytosanitary product 5.

Advantageously, the pneumatic circuit 4 can comprise a control device (not shown) configured to control the amount of air to be injected into the inflatable membrane 36.

The outlet of the phytosanitary product 5 may include a duct 50, a valve 51 and a pump 52.

In particular, the duct 50 is configured to convey the phytosanitary product from the closing device 3 to the spraying boom of the agricultural machine. In addition, the duct 50 connects the first opening 33 of the closing device 3 to the valve 51, the valve 51 to the pump 52 and the pump 52 to the spray boom.

Once switched on, the pump 52 enables the circulation of the phytosanitary product from the can 2 to the inlet of the pump 52.

The valve 51 can be a simple check valve, for example.

The valve 51 allows the passage of the phytosanitary product in the discharge direction of the phytosanitary product in the can 2, i.e. from the closing device 3 to the spray boom. On the contrary, the valve 51 prevents the circulation of the phytosanitary product in the opposite direction, i.e. in the direction of the can 2.

Thus, once the pump 52 has been switched on, the phytosanitary product is conveyed from the can 2, to the valve 51 and then to the inlet of the pump 52 and then to the spraying boom.

Advantageously, the extracting device 1 can further include a closing member (not shown) between the closing device 3 and the valve 51. The said closing member is configured to prevent the flow of the phytosanitary product contained in the can 2, in particular by gravity when placing the can 2 in the extracting device 1 or when installing the closing device 3 on the can 2, for example. The closing device can for example be a tap, a standard coupler, etc.

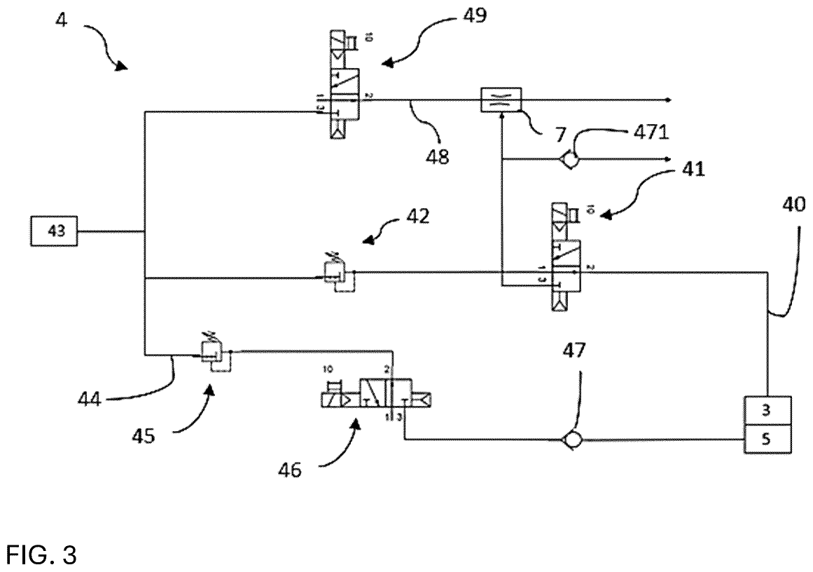

The pneumatic circuit 4 shown in FIG. 3 may include a duct 40 connecting the closing device 3 to a distributor 41, which is itself connected by the duct 40 to a pressure regulator 42 connected to a compressed air inlet 43.

In particular, the duct 40 connects the second opening 34 of the closing device 3 to the compressed air inlet 43.

The compressed air inlet 43 conveys compressed air to the pressure regulator 42 which allows the air pressure to be maintained and controlled. The injection of compressed air into the inflatable membrane 36 allows the expansion of the said membrane 36, which generates an overpressure in the can 2. The expansion of the inflatable membrane 36 and the overpressure generated in the can 2 allow the liquid to be sprayed to be conveyed to the first opening 33 of the closing device 3 connected to an outlet of phytosanitary product.

In addition, the pneumatic circuit 4 may further comprise a duct 44 connecting the compressed air inlet 43 to a pressure regulator 45, which is itself connected by the duct 44 to an air flushing distributor 46. The air flushing distributor 46 is also connected by another duct to a valve 47 connected to the outlet of the phytosanitary product 5.

The compressed air inlet 43 conveys compressed air to the pressure regulator 45 which maintains and controls the air pressure, and then to the air flushing distributor 46 which allows it to be conveyed in the duct of the outlet of the phytosanitary product 5, to the spray boom. The injection of air into the ducts up to the spray boom allows to flush with air the ducts through which the sprayed phytosanitary product was conveyed. In particular, the pneumatic circuit 4 allows here the phytosanitary product particles remaining in the ducts to be discharged.

In addition, the pneumatic circuit 4 may further comprise a duct 48 connecting the compressed air inlet 43 to a distributor 49, which is itself connected by the duct 48 to a vacuum generator 7. In addition, the distributor 41 is connected to the vacuum generator 7. The vacuum generator 7 is responsible for accelerating the air present in the duct 48 in order to create a vacuum in this duct 48, so as to suck in the air present in the inflatable membrane 36 and thus deflate it. The pressure inside the inflatable membrane 36 can then possibly be lower than the atmospheric pressure. The said vacuum generator 7 works due to the venturi effect.

The distributor 49 allows the vacuum generator 7 to be activated when it is desired to deflate the inflatable membrane 36.

Once the can 2 has been emptied of the phytosanitary product, the vacuum generator 7 would then allow to suck in the air contained in the inflatable membrane 36, which has been decompressed by the distributor 41, which would cause its contraction in the can 2.

The vacuum generator 7 can, for example, be a venturi.

In parallel with the vacuum generator 7, in particular the venturi, there may be provided, still with respect to FIG. 3, a valve 471 allowing to decompress the inflatable membrane 36 without passing through the vacuum generator 7. The inflatable membrane 36 is then not drawn into a vacuum, so the pressure inside the inflatable membrane 36 cannot be lower than the atmospheric pressure. In this embodiment, according to a first mode of operation, the distributor 49 allows the compressed air to pass through and the inflatable membrane 36 is decompressed, by means of the vacuum generator 7, through the distributor 41, which is described above. According to a second mode of operation, the distributor 49 does not allow the compressed air to pass through, so the distributor 41 being then in a position configured to allow the air contained in the inflatable membrane 36 to pass through, which has no other choice but to exit through the valve 471.

The hydraulic flushing circuit 6 is connected by a duct 60 to a valve 61, which is itself connected to the valve 62, which is itself connected to the third opening 35 of the closing device 3.

The hydraulic flushing circuit 6 allows the delivery of flushing liquid such as clear water through the duct 60, then through the valve 61 and the valve 62 to the third opening 35 of the closing device 3, and then into the can 2.

The valve 62 can be a simple check valve, for example.

The valve 62 allows clear water to flow into the inside of the can 2, i.e. in the direction of the closing device 3. On the contrary, the valve 62 prevents the flow of clear water in the opposite direction, i.e. in the direction of the hydraulic circuit 6.

Also in this embodiment, the extracting device 1 can further advantageously include a closing member (not shown) between the closing device 3 and the valve 62. Said closing member is configured to prevent the flow of the phytosanitary product contained in the can 2, in particular by gravity when placing the can 2 in the extracting device 1 or when installing the closing device 3 on the can 2, for example. The closing member can for example be a tap, a standard coupler, etc.

The hydraulic flushing circuit 6 is configured to flush with clear water, e.g. the can 2, after the phytosanitary product has been discharged. In particular, the hydraulic flushing circuit 6 allows the discharge of the phytosanitary product particles remaining in the can 2, as well as on the inflatable membrane 36.

Thus, the hydraulic circuit 6 prevents stagnation of the phytosanitary product in the can 2.

When the can 2 is completely filled with phytosanitary product, in its initial position, the inflatable membrane 36 is completely retracted and extends inside the can 2. When it is desired to spray a phytosanitary product, the phytosanitary product is discharged from the can 2. The pneumatic circuit 4, through its compressed air inlet 43, conveys compressed air to the pressure regulator 42 before conveying it into the inflatable membrane 36. The injection of compressed air into the inflatable membrane 36 allows the expansion of the said membrane 36, which generates an overpressure in the can 2. The expansion of the inflatable membrane 36 and the overpressure generated in the can 2 allow the liquid to be sprayed to be conveyed to the first opening 33 of the closing device 3 connected to an outlet of phytosanitary product. The inflatable membrane 36 expands to discharge the amount of phytosanitary product required for spraying. The inflatable membrane 36 allows the phytosanitary product to be pushed out of the can 2. In particular, the inflatable membrane 36 is configured to conform to the inner wall of the expanding can 2 and to push the phytosanitary product, even if it is stuck in a portion of the enclosure of the can 2.

Once the phytosanitary product has been completely discharged from the can 2, the vacuum generator 7 of the pneumatic circuit 4 can suck in the air contained in the inflatable membrane 36, which would first pass through the distributor 41 which would allow the air to be conveyed to the vacuum generator 7, which would cause its contraction in the can 2.

Then, the hydraulic flushing circuit 6 conveys flushing liquid such as clear water into the can 2, through the duct 60, then through the valve 61 and the valve 62 to the third opening 35 of the closing device 3. The clear water thus conveyed into the can 2 allows to discharge the phytosanitary product particles remaining in the can 2 and on the inflatable membrane 36.

The clear water containing the phytosanitary product particles then forms grey water. This grey water is discharged through the duct 50. The grey water is then conveyed, for example, to the spraying boom of the agricultural machine or to a tank for storage before spraying.

Finally, the compressed air inlet 43 of the pneumatic circuit 4 conveys compressed air to the pressure regulator 45 and then to the air flushing distributor 46 before conveying it through the duct of the outlet of the phytosanitary product 5, up to the spray boom. The injection of air into the ducts up to the spray boom allows to flush with air the ducts through which the sprayed phytosanitary product and/or the grey water have been conveyed. In particular, the pneumatic circuit 4 allows here the phytosanitary product particles remaining in the ducts to be discharged.

The closure device 3 can be single-use or reusable.

In the event that the closing device 3 is reusable, it can be removed from the empty can 2 and flushed and then mounted on another filled can 2 containing the same phytosanitary product or any other liquid.

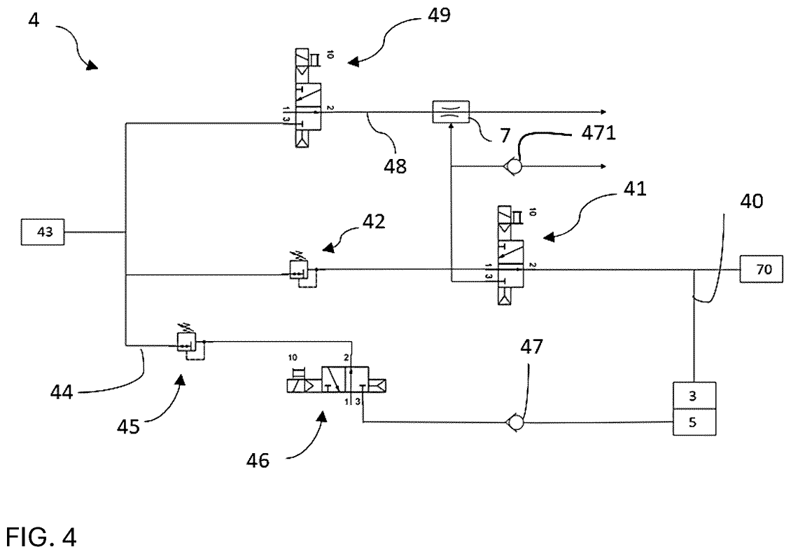

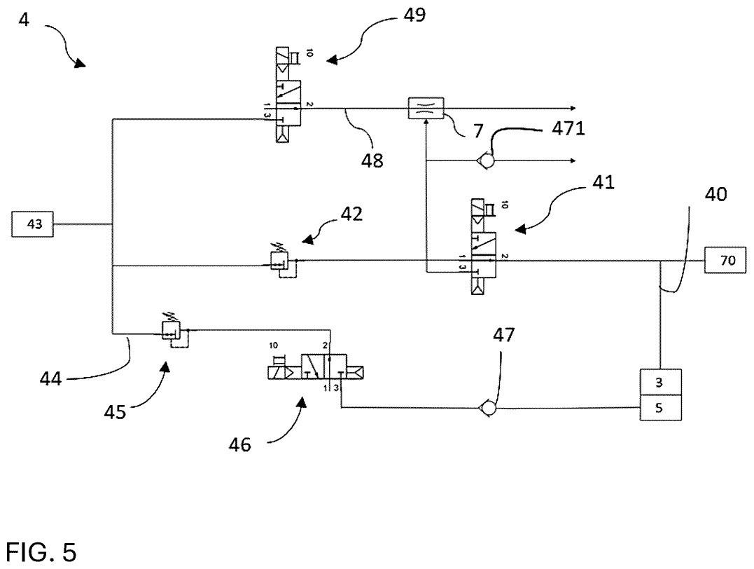

FIG. 4 and FIG. 5 show schematically a particular embodiment, in which the can and the cap are disposed in a pressurized enclosure. FIG. 4 is identical to FIG. 3, except that it shows the pressurized enclosure 70. FIG. 5 is identical to FIG. 1, except that it shows the pressurized enclosure 70.

According to the embodiment shown in FIG. 4 and FIG. 5, it is thus possible to place the entire extracting device 1, as well as the can 2, in a closed pressurized enclosure 70. The pressurized enclosure 70 is configured to withstand high pressures, in particular of the order of or greater than 6 bars, for example of the order of 10 bars. It is then possible to pressurize this pressurized enclosure 70 at the same time as the fluid contained inside the can 2, due to the air regulator 42. This allows to maintain the same pressure inside the pressurized enclosure 70 and inside the inflatable membrane 36 and consequently inside the can 2. Therefore, there is then no pressure difference between the inside and the outside of the can 2. It is therefore possible to apply a greater pressure on the can 2, regardless of its intrinsic physical characteristics of resistance to pressure, because of this balance between the pressure inside the can 2 and the pressure maintained in the pressurized enclosure 70 and therefore applied to the outside of the can 2.

The difference between the pressure of the phytosanitary product and the atmospheric pressure is, in this embodiment, potentially high. For example, a pressure of about ten bars can be maintained in the pressurized enclosure 70. This can also allow to supply the spray boom with phytosanitary product without the use of a pump 52 to inject the phytosanitary product.

It should also be noted that the invention is not limited to the embodiments described above. It will indeed appear to those skilled in the art that various modifications can be made to the embodiment described above, in the light of the teaching which has just been disclosed to them.

In particular, according to a variant, the vacuum generator 7 is omitted and the inflatable membrane 36 no longer deflates by means of the vacuum generator 7 but in contact with the clear water conveyed to the can 2 for flushing.

In the detailed presentation of the invention above, the terms used must not be interpreted as limiting the invention to the embodiment set out in this description, but must be interpreted to include all equivalents which can be foreseen by those skilled in the art by applying their general knowledge to the implementation of the teaching which has just been disclosed to them.

1. A closing device configured to cooperate with a hydraulic flushing circuit, with a pneumatic circuit for agricultural spraying system, with an outlet of phytosanitary product and with a can of phytosanitary product, the closing device comprising:
at least a bottom wall; and
at least a peripheral wall;
the closing device being configured to close the can,
the peripheral wall protruding from the bottom wall, said bottom wall comprising at least three through openings, namely a first opening, a second opening and a third opening, the first opening being configured to be connected to the outlet of phytosanitary product allowing the said phytosanitary product to be discharged from said can, the second opening being on the one hand configured to open in a sealed manner into an inflatable membrane and on the other hand configured to be connected to an inlet of the pneumatic circuit, so as to allow an overpressure to be generated in the can by the expansion of the inflatable membrane by means of the pneumatic circuit, said third opening being configured to be connected to an inlet of said hydraulic flushing circuit.

2. The closing device according to claim 1, further comprising an inflatable membrane, said inflatable membrane being connected to the second opening of the bottom wall, said inflatable membrane being configured to expand and/or contract by means of the pneumatic circuit, the inflatable membrane being disposed on the same side of the bottom wall as the peripheral wall.

3. The closing device according to claim 2, wherein the inflatable membrane is a flexible expandable membrane.

4. An extracting device of phytosanitary product from a can of phytosanitary product, comprising:
at least a closing device according to claim 1;
at least a pneumatic circuit; and
at least an outlet of phytosanitary product;
said closing device comprising at least an inflatable membrane, at least a bottom wall and at least a peripheral wall protruding from the bottom wall, said bottom wall comprising at least two through openings, a first opening and a second opening, the first opening being connected to an outlet of phytosanitary product allowing the said phytosanitary product to be discharged from said can, the second opening being on the one hand connected to the inflatable membrane and on the other hand connected to a pneumatic circuit inlet, said inflatable membrane being configured to expand and/or contract by means of the pneumatic circuit, the inflatable membrane being disposed on the same side of the bottom wall as the peripheral wall.

5. The extracting device according to claim 4, wherein the pneumatic circuit comprises at least a duct, a distributor, a pressure regulator and a compressed air inlet, the duct connecting the closing device to the distributor, which is itself connected by said duct to the pressure regulator connected to the compressed air inlet, said pneumatic circuit being configured to allow the expansion of the inflatable membrane.

6. The extracting device according to claim 5, wherein the pneumatic circuit further comprises a vacuum generator, said duct connecting the vacuum generator to the distributor, said vacuum generator being configured to suck in the air contained in the inflatable membrane, causing its contraction.

7. The extracting device according to claim 5, wherein the pneumatic circuit further comprises a duct, an air flushing distributor and a pressure regulator, said duct connecting the compressed air inlet to the pressure regulator, which is itself connected by said duct to the air flushing distributor, which is itself connected to the outlet of phytosanitary product, said pneumatic circuit being configured to allow air flushing of the outlet of phytosanitary product.

8. The extracting device according to claim 4, further comprising a hydraulic flushing circuit and wherein the bottom wall of the closing device has a third through opening connected to an inlet of said hydraulic flushing circuit, configured to allow the flushing of the can and the inflatable membrane.

9. A liquid spraying system comprising an extracting device according to claim 4 and further comprising a can configured to contain a phytosanitary product and to which said closing device is fixed, the can being on the one hand connected, by the first opening of the closing device, to a duct of the outlet of the treatment liquid configured to convey the phytosanitary product from the can to at least one spray nozzle, the can being on the other hand connected by the third opening of the closing device to an inlet duct of the hydraulic flushing circuit configured to convey flushing liquid into the can so that said flushing liquid flushes said can, and said can being connected by the second opening of the closing device to an inlet duct of the pneumatic circuit and to the inflatable membrane, said inlet duct of the pneumatic circuit being configured to convey fluid into the inflatable membrane so that it expands into the enclosure of the can, the expansion of said inflatable membrane being configured to pressurize the phytosanitary product in the can so as to create a flow of said phytosanitary product towards the outlet of the phytosanitary product.

10. The liquid spraying system according to claim 9, comprising a pressurized enclosure, the can and the extracting device being disposed inside the pressurized enclosure.
